(19) United States
(12) Patent Application Publication
(10) Pub. No.: US 2008/0056418 A1
(43) Pub. Date: Mar. 6, 2008

(54) COMMUNICATION APPARATUS, COMMUNICATION SYSTEM, SYNCHRONIZATION METHOD, AND COMMUNICATION APPARATUS CONTROL PROGRAM

(75) Inventors: Hirosuke Miki, Tenri-Shi (JP); Yoshihiro Ohtani, Seika-Cho (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 11/848,086

(22) Filed: Aug. 30, 2007

(30) Foreign Application Priority Data
Sep. 4, 2006 (JP) 2006-239556

(51) Int. Cl. H04L 7/02

(52) U.S. Cl. 375/354

(57) ABSTRACT

A communication system includes: a communication apparatus which is a clock master including an upper clock indicating a first apparatus time; a time detection section which detects the first apparatus time and a first reference time at substantially the same time; and a sending section by which the detected first apparatus time and first reference time to a non-clock master; a communication apparatus which is a non-clock master including an upper clock indicating a second apparatus time; a time detection section which at substantially the same time detects a second reference time synchronized with the first reference time and the detected second apparatus time; a receiving section receiving the first apparatus time and the first reference time; and an adjustment section by which the upper clock is adjusted with reference to the second apparatus time, the second reference time, the first apparatus time, and the first reference time. With this, communication apparatuses communicating with one another in a communication system can synchronize their apparatus times without performing simultaneous time detection in the respective communication apparatuses.

This Nonprovisional application claims priority under 35 U.S.C. §119(a) on Patent Application No. 239556/2006 filed in Japan on Sep. 4, 2006, the entire contents of which are hereby incorporated by reference.

### FIELD OF THE INVENTION

The present invention relates to a communication apparatus, a communication system, a communication apparatus control program, and a storage medium, which performs time synchronization between communication apparatuses.

### BACKGROUND OF THE INVENTION

There have conventionally been known communication networks including a plural number of terminal apparatuses. FIG. 6 shows an example of such a communication network. In the figure, the communication network 40 is constituted by a terminal apparatus 1, a terminal apparatus 2, and a terminal apparatus 3. The terminal apparatus 1 includes a communication apparatus 10, the terminal apparatus 2 include a communication apparatus 20, and the terminal apparatus 3 includes a communication apparatus 30,

Assume that the terminal apparatus 1 sends, to the terminal apparatuses 2 and 3, stream data such as video and audio data, which is required to have assured real-timeness. Each of the communication apparatuses 10, 20, and 30 has a clock which is referenced to when, for example, video or audio data are decoded. The time indicated by the clock typically has an error in the range of precision of its crystal oscillator.

Provided that a time at which the oscillating frequency of the crystal oscillator is identical with the nominal frequency is termed standard time, times indicated by the clocks of the respective communication apparatuses 10, 20, and 30 are faster than or later than the standard time, as shown in FIG. 7. Furthermore, the paces of the clocks of the respective communication apparatuses 10, 20, and 30 are different from one another. Therefore, as shown in FIG. 8, the times of the respective communication apparatuses 10, 20, and 30 are different from one another.

The terminal apparatuses 1, 2, and 3 may be AV (Audio Visual) equipments dealing with video and audio data. Examples of such an AV equipment includes an audio equipment, a television receiver, a home theater, and a projector, which are connectable with a communication network.

An adverse effect may occur if times indicated by the respective terminal apparatuses 1, 2, and 3 are different from one another. For example, in order to reproduce a moving image content, video data is supplied from the communication apparatus 10 storing the moving image content to the communication apparatus 20 and is reproduced real-time, while audio data is also supplied from the communication apparatus 10 to the communication apparatus 30 real-time. In this connection, it is clear that the time of the communication apparatus 20 and the time of the communication apparatus 30 must be highly precisely synchronized with one another.

Examples of methods for realizing such synchronization include (i) a method such that both the time of the communication apparatus 20 and the time of the communication apparatus 30 are synchronized with the time of the communication apparatus 10; a method such that the time of the communication apparatus 30 is arranged to be synchronized with the time of the communication apparatus 20; and a method such that the time of the communication apparatus 20 is arranged to be synchronized with the time of the communication apparatus 30.

It is noted that, hereinafter, “a clock of a terminal apparatus” indicates a clock of a communication apparatus in a terminal apparatus.

Communication functions of the communication apparatus are typically achieved by using plural layers (protocol stacks). Each of the layers may have an individual clock. For example, as shown in FIG. 9, the communication apparatuses 10 and 20 have two layers, i.e. upper layers 11 and 21 and lower layers 12 and 22, respectively, and each layer is provided with a clock.

The clock of the lower layer 12 or 22 is typically not synchronized with the clock of the upper layer 11 or 21, because the upper and lower layers are used for different objectives, respectively. On the other hand, the clocks of the same layers are required to be synchronized with one another. More specifically, the clocks of the respective upper layers 11 and 21 are required to be synchronized with each other and the clocks of the respective lower layers 12 and 22 are required to be synchronized with each other, whereas the clock of the upper layer 11 and the clock of the lower layer 12 are typically not required to be synchronized with each other.

On a wireless LAN (Local Area Network) conforming to IEEE802.11, upper layers can be synchronized with one another by a technique disclosed by U.S. Patent Publication No. 2003/0172179 (published on Sep. 11, 2003; hereinafter, patent document 1). In this technique, the lower layer is a wireless LAN layer. Each of upper layers has an independent clock, and the clocks are synchronized with one another by selecting a single communication apparatus to function as a clock master at the upper layer level.

As shown in FIG. 10, the clock master regularly samples the clock, puts the sampled time in a multicast frame (whose identifier information is “n”) for synchronization, and sends the frame to another communication apparatus with which the time is to be shared.

The clock master samples the timing information when the clock master sends or receives the last part of a multicast frame for synchronization, and records the time (t^{TX}[n]) of the clock of the upper layer at the timing.

Another communication apparatus which is not a clock master samples the timing information when it receives the last part of the frame, and records the time (t^{RX}[n]) of the clock of the upper layer at the timing.

The communication apparatuses must be designed to allow the wireless LAN layer to precisely notify the upper layer of the timing when it sent or received the last part of the frame.

The clock master puts, into the next multicast frame (whose identifier information is n+1) for synchronization, the identifier information n and the time t^{TX}[n] of the multicast frame which was sent by the clock master last time, and the clock master sends the next multicast frame to a non-clock master.

Receiving the multicast frame with the identifier information of (n+1), the non-clock master compares the time t^{TX}[n] embedded in the supplied multicast frame with the time t^{RX}[n] stored in the non-clock master, in order to compare the time of the clock of the upper layer of the non-clock master with the time of the clock of the upper layer of the clock master, at the timing of sending or receiving the synchronization multicast frame whose identifier information is n.

A multicast frame is sent without using acknowledgement (ACK). For this reason, the time when the clock master sends the frame and the time when the non-clock master receives the frame are assumed to be substantially the same. Therefore, by comparing the times, the non-clock master apparatus can grasp whether the time of the clock of the same is faster or later than the time of the clock of the clock master, and it can adjust its clock time to the time of the clock master.

However, in case where the synchronization method taught by the patent document 1 is used for IEEE802.11e, a communication apparatus which can send a multicast frame on the wireless LAN layer is only an AP (Access Point) which is the central apparatus.

Therefore, in case where the clock master is not an AP, the clock master is required to send a synchronization multicast frame to the AP and then the AP multicasts the supplied frame to all apparatuses. In this way, the sending of the synchronization frame requires those two steps, requiring more bandwidth.

Also, in case where the synchronization method of the patent document 1 is adopted, a MAC layer which is a lower layer is required to discern a special multicast frame used in the method from other frames and to promptly give notification to an upper layer. The MAC layer is therefore required to recognize the special multicast frame.

A network AV equipment is constituted by plural blocks, and examples of blocks connected to an upper layer of a network AV equipment are a lower layer and an AV layer. The AV layer is a layer that process audio and video such as MPEG (Moving Picture Experts Group). Since technologies required to respective blocks are different, the blocks are typically made by different manufacturers.

In case of the synchronization method of the patent document 1, since an upper layer uses a lower layer manufactured by a different manufacturer, the lower layer is required to support the synchronization method of the patent document 1.

A MAC layer which has a capability of supporting the synchronization method is only a chip set conforming to IEEE802.11e. This function, however, is optional in IEEE802.11e, and hence is unlikely to be implemented. Standards other than IEEE802.11e do not define the function, and hence the function will not be implemented in, for example, PLC (Power Line Communication).

### SUMMARY OF THE INVENTION

The present invention was done to solve the above-identified problem, and the objective of the present invention is to provide a communication apparatus, communication system, a synchronization method, a communication apparatus control program, and a storage medium storing the communication apparatus control program, by which plural communication apparatuses communicating with one another in a communication system can synchronize their apparatus times without simultaneous time detections in the respective communication apparatuses.

(A) To achieve the objective above, the communication apparatus of the present invention, which is a clock master, includes: a first apparatus time clocking section for clocking a first apparatus time of the communication apparatus; a first time detection section for executing a time detection process to detect, substantially at the same time, the first apparatus time and a first reference time synchronized with a second reference time referred to by a non-clock master; and a sending section for sending, to the non-clock master, the detected first apparatus time and first reference time.

To achieve the objective above, the communication apparatus of the present invention, which is a non-clock master and synchronizes a first apparatus time of a clock master with a second apparatus time which is a time of the communication apparatus, includes: a second apparatus time clocking section for clocking the second apparatus time; a second time detection section for performing a time detection process to detect, substantially at the same time, the second apparatus time and a second reference time synchronized with a first reference time referred to by the clock master; a receiving section for receiving the first apparatus time and the first reference time from the clock master; and a time adjustment section for adjusting the second apparatus time, with reference to the detected second apparatus time, the detected second reference time, the received first apparatus time, and the received first reference time.

To achieve the objective above, a communication system of the present invention includes: a communication apparatus which is a clock master; and a communication apparatus which is a non-clock master, the communication apparatus as the clock master including: a first apparatus time clocking section for clocking a first apparatus time of the clock master; a first time detection section for executing a time detection process to detect, substantially at the same time, the first apparatus time and a first reference time synchronized with a second reference time referred to by the non-clock master; and a sending section for sending, to the non-clock master, the detected first apparatus time and first reference time, the communication apparatus as the non-clock master, which synchronizes the first apparatus time of the clock master with the second apparatus time which is a time of the non-clock master, including: a second apparatus time clocking section for clocking the second apparatus time; a second time detection section for performing a time detection process to detect, substantially at the same time, the second apparatus time and the second reference time synchronized with the first reference time referred to by the clock master; a receiving section for receiving the first apparatus time and the first reference time from the clock master; and a time adjustment section for adjusting the second apparatus time, with reference to the detected second apparatus time, the detected second reference time, the received first apparatus time, and the received first reference time.

To achieve the objective above, a synchronization method of the present invention, for synchronizing a first apparatus time which is a time of a clock master with a second apparatus time which is a time of a non-clock master, includes the steps, executed by a communication apparatus as the clock master, of: clocking the first apparatus time; detecting, substantially at the same time, the first apparatus time and a first reference time which is synchronized with a second reference time referred to by the non-clock master; and sending the detected first apparatus time and first reference time to the non-clock master, the method further including the steps, executed by a communication apparatus as the non-clock master, of: clocking the second apparatus time; detecting, substantially at the same time, the second apparatus time and the second reference time; receiving the first apparatus time and the first reference time; and adjusting the second apparatus time with reference to the detected second apparatus time, the detected second reference time, the received first apparatus time, and the first reference time.

The clock master is constituted by a first apparatus time clocking section, a first time detection section, and a sending section. The first time detection section detects, substantially at the same time, the first apparatus time and the first reference time. The first time detection section sends both of the detected times to a non-clock master, via the sending section.

The non-clock master is constituted by a second apparatus time clocking section, a second time detection section, a receiving section, and a time adjustment section. The second time detection section detects, substantially at the same time, the second reference time and the second apparatus time clocked by the second apparatus time clocking section. The receiving section receives the first apparatus time and first reference time supplied from the clock master.

The term “substantially at the same time” includes the following two cases: the first apparatus time and the first reference time are completely simultaneously detected; and there is a small gap between the time point at which one of the times is detected and the time point at which the other time is detected.

According to the aforesaid arrangements and method, the time adjustment section adjusts the time of the second apparatus time clocking section, with reference to the received first apparatus time, the received first reference time, the detected second apparatus time, and the detected second reference time. It is noted that the first reference time and the second reference time are synchronized with one another.

In the arrangement, the timing at which the first reference time is detected is arranged to correspond to the timing at which the first apparatus time is detected, whereas the timing at which the second reference time is detected is arranged to correspond to the timing at which the second apparatus time is detected.

Optimally the timing at which the first reference time is detected is identical with the timing at which the first apparatus time is detected. However, a little gap may occur in some type of systems.

A time difference between the timing to detect the first apparatus time and the timing to detect the second apparatus time is close to a time difference TD between the timing to detect the first reference time and the timing to detect the second reference time.

The first apparatus time and the second apparatus time are therefore not simultaneously detected. However, by reflecting the time difference TD to the detected first and second apparatus times, it is possible to acquire an effect similar to the effect of the conventional art taught in the patent document 1, in which the first and second apparatus times are simultaneously detected.

According to the arrangement above, synchronization between the first and second apparatus times is achieved by using a difference between the second reference time and the first reference time. Therefore, being different from the conventional art, it is unnecessary to simultaneously detect the first and second apparatus times.

Since it is unnecessary to simultaneously detect the first and second apparatus times, a multicast frame used for simultaneous sampling in the synchronization taught by the conventional art is unnecessary.

Also, since a multicast frame is not required, in other words, since a frame to send the first apparatus time and the first reference time from the clock master to the non-clock master is not required to be a multicast frame, the first apparatus time and the first reference time can be transmitted by a uni-cast frame, even if the transmission is performed based on IEEE802.11e.

That is, being different from the convention art in which transmission is performed in two steps through the intermediary of an AP, transmission is performed in a single step without the intermediary of an AP. On this account, in case where there is a single non-clock master, the synchronization method of the present invention requires a smaller bandwidth in a wireless LAN conforming to IEEE802.11e.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 shows a basic idea of the present invention.

FIG. 2 is a timing chart for illustrating a gap between time detection timings in the present invention.

FIG. 3 is a functional block diagram outlining a communication system of the first embodiment,

FIG. 4 is a timing chart showing the steps of time synchronization in the first embodiment.

FIG. 5 is a functional block diagram outlining a communication system of the second embodiment.

FIG. 6 outlines a communication system of the conventional art.

FIG. 7 is a graph showing the relationship between passage of time and a deviation in time.

FIG. 8 shows a deviation of time in the communication system of the conventional art.

FIG. 9 shows the relationship in regard to synchronization between upper layers and lower layers of a communication apparatus.

FIG. 10 shows the steps of time synchronization of the conventional art.

FIG. 11 is a timing chart for illustrating a gap between time detection timings in the conventional art.

### DESCRIPTION OF THE EMBODIMENTS

<Outline of Present Invention>

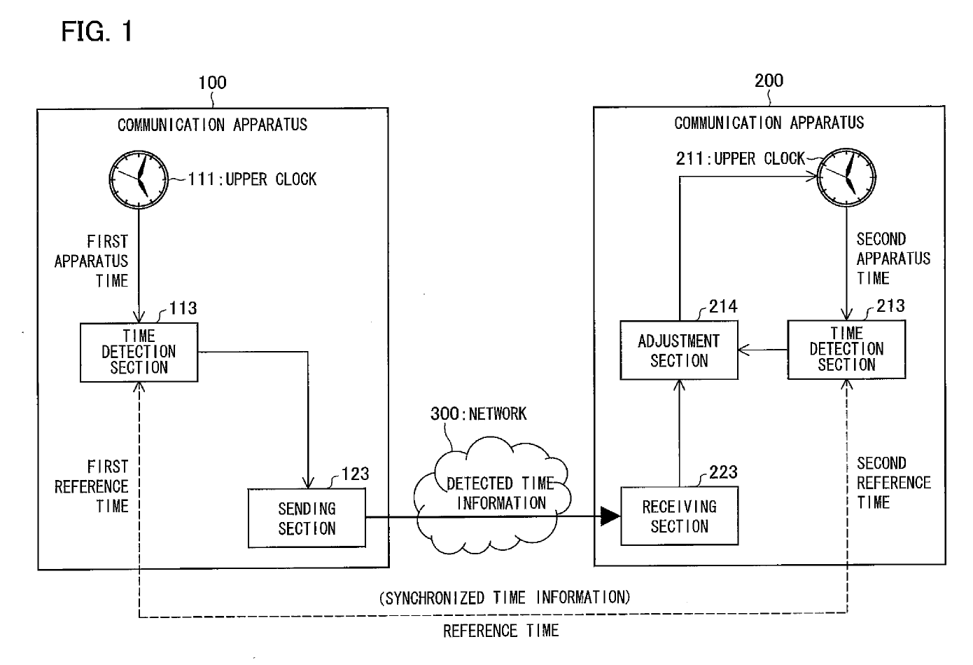

The outline of the present invention will be given with reference to FIG. 1. A communication apparatus 100 is a clock master, whereas a communication apparatus 200 is a non-clock master. The communication apparatus 100 and the communication apparatus 200 perform processes requiring time synchronization between the apparatuses, such as sending and playing a moving image content.

The communication apparatus 100 includes an upper clock 111 (first apparatus time clocking means), a time detection section 113 (first time detection means), and a sending section 123 (sending means). The time detection section 113 detects a first apparatus time indicated by the upper clock 111 and a first reference time. The detected times are supplied, as detected time information, to the communication apparatus 200 via the sending section 123.

The communication apparatus 200 is constituted by an upper clock 211 (second apparatus time clocking means), a time detection section 213 (second time detection means), a receiving section 223 (receiving means), and an adjustment section 214 (time adjustment means). The time detection section 213 detects a second apparatus time indicated by the upper clock 211 and a second reference time. The receiving section 223 receives detected time information supplied by the communication apparatus 100.

According to the arrangement above, the adjustment section 214 adjusts the upper clock 211 with reference to the detected time information and the detected second apparatus time and second reference time. The first reference time is synchronized with the second reference time.

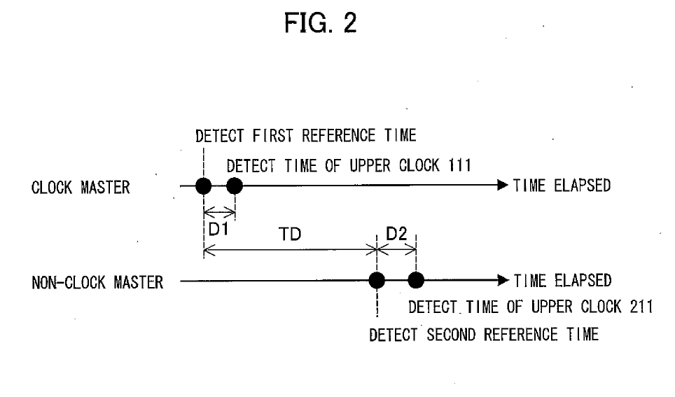

In the present arrangement, as shown in FIG. 2, a timing to detect the first reference time corresponds to a timing to detect the first apparatus time, and a timing to detect the second reference time corresponds to a timing to detect the second apparatus time.

The timing to detect the first reference time is ideally identical with the timing to detect the first apparatus time, but a little gap may occur in some type of systems. This gap is represented as D1 in FIG. 2. Similarly, in some types of systems, a little gap D2 may occur between the timing to detect the second reference time and the timing to detect the second apparatus time.

Provided that a time difference between the time point at which the first reference time is detected and the time point at which the second reference time is detected is TD, a difference between the time point at which the first apparatus time is detected and the time point at which the second apparatus time is detected is similar to TD.

Therefore, although the first apparatus time and the second apparatus time cannot be detected at the same time, an effect similar to the effect of the conventional art that the first apparatus time and the second apparatus time are detected at the same time can be acquired by reflecting the time different TD to the detected first apparatus time and second apparatus time.

To put it specifically, provided that the detected first reference time is 1100 μs, the detected first apparatus time is 330 μs, the detected second reference time is 1005 μs, and the detected second apparatus time is 220 μs, the difference between the second reference time and the first reference time is worked out as follows:

1005 μs−1100 μs=−95 μs.

The difference is reflected to, for example, the first apparatus time as follows: 330 μs−95 μs=225 μs. To adjust the upper clock 211, the time difference of 225 μs is compared with the second apparatus time (220 μs) and a difference (220 μs−225 μs=−5 μs) is worked out, and the upper clock 211 is adjusted in accordance with this difference.

In the meanwhile, according to the conventional art, a non-clock master adjusts the clock of the same with reference to two sets of information (time t^{TX}[n] of the clock of the clock master and time t^{RX}[n] of the clock of the non-clock master). In order to prevent deterioration in precision of synchronization of the clock of the non-clock master, the aforesaid two sets of information must be sampled (detected) at the same time. In doing so, using a multicast frame, the clock master and the non-clock master simultaneously sample the times of the clocks of the respective apparatuses with an assumption that at an time point at which the last part of the multicast frame is sent or received is used as a reference point.

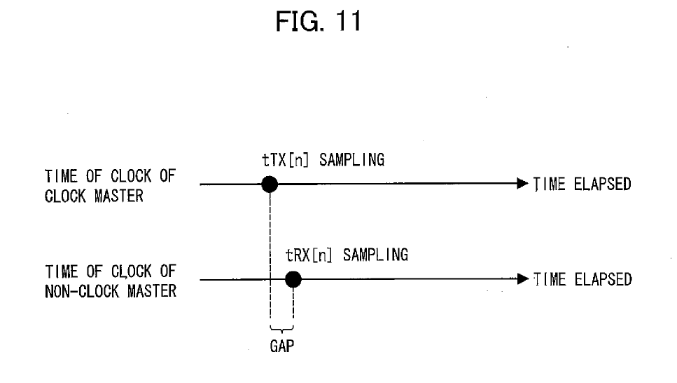

However, as shown in FIG. 11, no matter how simultaneous sampling is attempted, a little gap occurs between time points of sampling, because of a difference in transmission times of frames and a difference in times required to process frames.

The difference between transmission times occurs because, in a wireless transmission path from a sender to a receiver, a radio wave is reflected plural times. For example, a reflection pattern of a radio wave changes in response to the movement of the user, and hence a transmission time is varied on account of the position and movement of the user.

The lower layer of a clock master is required to notify the upper layer of the reference point of the last part of the multicast frame which has been sent, whereas the lower layer of a non-clock master is required to notify the upper layer of the reference point of the last part of the multicast frame which has been received. Since a process for sending is different from a process for receiving, the frame processing time from the start of the process to send the multicast frame to the recognition of the last part and notification to the upper layer is different from the frame processing time from the start of the process to receive the multicast frame to the recognition of the last part and notification to the upper layer.

In case where the synchronization method of the conventional art is adopted to IEEE802.11e and a clock master is not an AP, a synchronizing multicast frame must be transmitted in two steps, that is, transmission from the clock master to the AP and transmission from the AP to a non-clock master.

According to the arrangement above, synchronization between the first and second apparatus times is achieved by using the difference between the second reference time and the first reference time. On this account, being different from the conventional art, it is unnecessary to detect the first and second apparatus times at the same time.

Since it is unnecessary to detect the first and second apparatus times at the same time, a multicast frame which is used for simultaneous sampling in the synchronization method of the conventional art is not needed.

Also, since a multicast frame is not required, in other words, since a frame to send the detected time information from a clock master to a non-clock master is not required to be a multicast frame, detected time information can be transmitted by a uni-cast frame, even if the transmission is performed based on IEEE802.11e.

Being different from the conventional art in which transmission is performed in two steps through the intermediary of an AP, transmission is performed in a single step without the intermediary of an AP. On this account, in case where there is a single non-clock master, the synchronization method of the present invention requires a smaller bandwidth in a wireless LAN conforming to IEEE802.11e.

In transmission of a moving image, in particular, transmission is typically performed from a home moving image server. In such a case, one to one transmission is highly probable, i.e. the number of non-clock master is likely to be one. On this account, the present invention which reduces the bandwidth used for synchronization in case where the number of non-clock master is one as compared to the conventional art is advantageous in the case above.

### First Embodiment

The following will describe an embodiment of the present invention with reference to figures.

<Communication System 400>

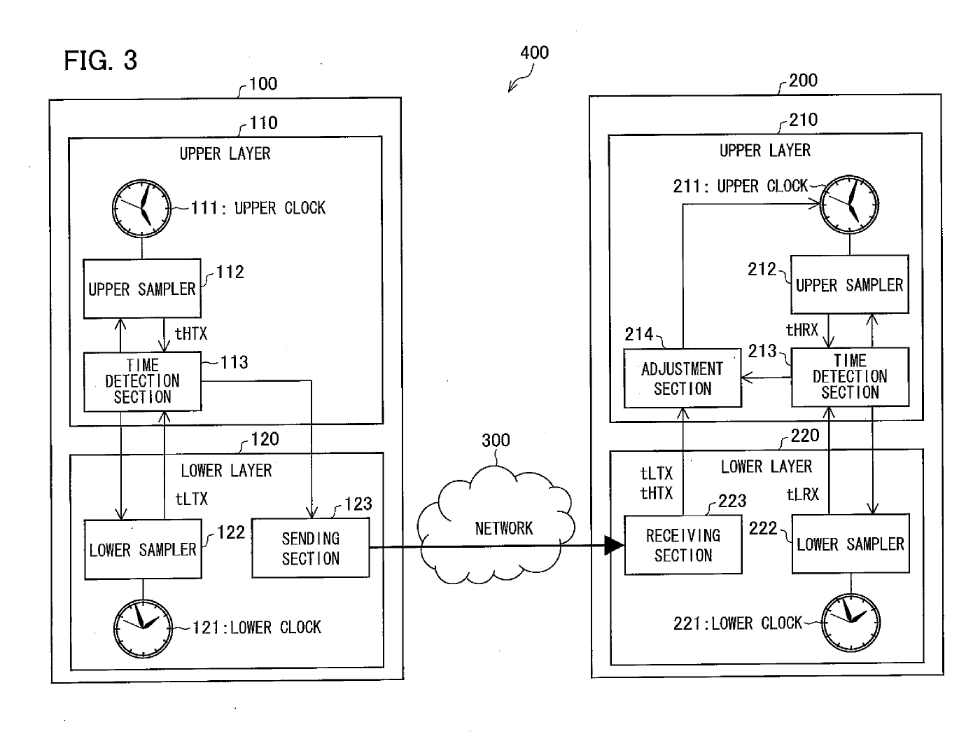

FIG. 3 outlines a communication system 400 of the present embodiment. The communication system 400 includes a communication apparatus 100 and a communication apparatus 200. The communication apparatus 100 and the communication apparatus 200 are connected one another over a network 300 so that time information can be exchanged therebetween.

<Communication Apparatuses 100 and 200>

The communication apparatus 100 includes, as protocol stacks for communications, an upper layer 110 and a lower layer 120. Similarly, the communication apparatus 200 includes, as protocol stacks for communications, an upper layer 210 and a lower layer 220. The upper layers 110 and 210 perform communications via the lower layers 120 and 220 and the network 300. The lower layers 120 and 220 are equivalent to a MAC layer for wired LAN, wireless LAN, and PLC.

<Acquisition of Reference Time from Lower Clock 121/221>

In the present embodiment, the lower layer 120 of the communication apparatus 100 has a lower clock 121 providing a reference time and the lower layer 120 acquires the reference time therefrom, whereas the lower layer 220 of the communication apparatus 200 has a lower clock 221 providing a reference time and the lower layer 220 acquires the reference time therefrom.

The upper layer 110 of the communication apparatus 100 includes an upper clock 111, a clock detection section 113, and an upper sampler 112 (first time detection means). The lower layer 120 includes a lower clock 121 (first reference time clocking means), a lower sampler 122 (first time detection means), and a sending section 123.

The upper layer 210 of the communication apparatus 200 includes an upper clock 211, a time detection section 213, an upper sampler 212 (first time detection means), and an adjustment section 214 (time adjustment means). The lower layer 220 includes a lower clock 211 (second reference time clocking means), a lower sampler 222 (second time detection means), and a receiving section 223.

In the present case, it is assumed that the lower clock 121 and the lower clock 221 are synchronized with each other.

For example, in case where the lower layers conform to IEEE802.11e, synchronization between the lower clocks 121 and 221 can be achieved by TSF (Timing Synchronization Function). That is to say, the lower clock 121 is used as a TSF timer of the wireless LAN layer of the communication apparatus 100 whereas the lower clock 221 is used as a TSF timer of the wireless LAN layer of the communication apparatus 200. The TSF timer (lower clock 121) of the wireless LAN layer of the communication apparatus 100 is synchronized with the TSF timer (lower clock 221), in accordance with IEEE802.11e. Also in cases where the lower layer is a wired LAN layer or a PLC layer, synchronization between the lower clocks 121 and 221 is assured by the standard.

The time detection section 113 of the communication apparatus 100 detects a time tHTX (first apparatus time) of the upper clock 111 and a time tLTX (first reference time) of the lower clock 121. The detected times tHTX and tLTX are reported to the communication apparatus 200 via the sending section 123.

To detect the time tLTX of the lower clock 121, first the time detection section 113 sends a detection request to the lower sampler 122. Then the lower sampler 122 samples the time tLTX of the lower clock 121 and sends the sampled time tLTX to the time detection section 113.

Similarly, to detect the time tHTX of the lower clock 111, first the time detection section 113 sends a detection request to the upper sampler 112. Then the upper sampler 112 samples the time tHTX of the upper clock 111 and sends the sampled time tHTX to the time detection section 113.

The time detection section 213 of the communication apparatus 200 detects a time tHRX (second apparatus time) of the upper clock 211 and a time tLRX (second reference time) of the lower clock 221. The receiving section 223 receives the detected time information supplied from the communication apparatus 100. The adjustment section 214 adjusts the time of the upper clock 211 with reference to the time tHRX, time tLRX, and detected time information.

To detect the time tLRX of the lower clock 221, first the time detection section 213 sends a detection request to the lower sampler 222. Then the lower sampler 222 samples the time tLRX of the lower clock 221 and sends the sampled time tLRX to the time detection section 213.

Similarly, to detect the time tHRX of the upper clock 211, the time detection section 213 sends a detection request to the upper sampler 212. Then the upper sampler 212 samples the time tHRX of the upper clock 211 and sends the sampled time tHRX to the time detection section 213.

<Adjustment of Upper Clock 211>

To adjust the upper clock 211, PLL (Phase Locked Loop) is typically adopted to the adjustment section 214.

In the adjustment adopting PLL, for example, it is assumed that synchronization is out if the difference (deviance) between the time of the upper clock 111 and the time of the upper clock 211 is larger than a predetermined value TH, as in the case of initialization of the communication apparatus 200. On this account, it is required to not perform fine adjustment of the time of the upper clock 211 over time but set the time of the upper clock 111 as the time of the upper clock 211. The predetermined value TH is set so as to be higher than target synchronization precision.

In case where the difference between the time of the upper clock 211 and the time of the upper clock 111 is smaller than the predetermined value TH, it is assumed that synchronization is achieved. Therefore, to keep the synchronization, the speed of the upper clock 211 is adjusted from time to time by using PLL.

In other words, the upper clock 111 and the upper clock 211 optimally perform PLL adjustment with reference to the time difference at the same point of time.

However, in the present system, the time of the upper clock 111 and the time of the upper clock 211 are not simultaneously sampled as shown in FIG. 2, and hence there is a time difference between the time points of sampling. This difference TD is compensated by using the time tLTX of the lower clock 121 and the time tLRX of the lower clock 221 which are synchronized with one another.

Therefore, the PLL adjustment is performed by figuring out the difference between (i) the difference between the times of the upper clocks 111 and 211 and (ii) the difference between the times of the lower clocks 121 and 221, worked out by the following equation (1).

PLL adjustment value=tHRX−tHTX−(tLRX−tLTX) (1)

In the equation (1), indicated by (tLRX−tLTX) is TD in FIG. 2.

The equation (1) can be transformed into the following equation (2).

PLL adjustment value=tHRX−tLRX−(tHTX−tLTX) (2)

In the equation (2), indicated by (tHTX−tLTX) is the difference between the reference time tLTX and the apparatus time tHTX, which has been detected by the time detection section 113.

That is to say, the communication apparatus 200 can adjust the time of the upper clock 211 only by receiving, as a non-clock master, the difference between the reference time tLTX and the apparatus time tHTX detected by the time detection section 113 from the communication apparatus 100 which is a clock master.

In this case, however, it is necessary to set the time of the upper clock 111 as the time of the upper clock 211, when synchronization is out because the difference between the times of the upper clocks 111 and 211 is larger than the predetermined value TH. On this account, it is necessary to send both the reference time tLTX and the apparatus time tHTX to the non-clock master.

For this reason, the adjustment section 214 of the non-clock master and the time detection section 113 of the clock master are required to recognize whether or not the upper clock 211 is synchronized with the upper clock 111.

In the initial state, the adjustment section 214 and the time detection section 113 recognize that synchronization is out.

When synchronization is out, the clock master sends both the reference time tLTX and the apparatus time tHTX to the non-clock master. When synchronization is achieved, a difference between the reference time tLTX and the apparatus time tHTX is sent.

When synchronization is out, the non-clock master receives the reference time tLTX and the apparatus time tHTX and sets the time of the upper clock 111 as the time of the upper clock 211. This setting makes the upper clock 211 be synchronized, and the adjustment section 214 notifies the clock master that the synchronization is achieved.

On the other hand, in case where the synchronization of the non-clock master has been achieved, the non-clock master receives the difference between the reference time tLTX and the apparatus time tHTX and figures out an adjustment value of PLL.

It is assumed that the synchronization is out when the PLL adjustment value is larger than the predetermined value TH. The adjustment section 214 becomes a state of out of synchronization and notifies the clock master of the out of synchronization.

In case where the PLL adjustment value is not larger than the predetermined value TH, the adjustment section 214 judges that the synchronization has been achieved and adjusts PLL.

The non-clock master is provided with a sending section (not illustrated) to notify the clock master of a synchronization state. The clock master is provided with a receiving section (not illustrated). In case where the adjustment section 214 of the non-clock master judges that it is necessary to notify the clock master of the synchronization state as above, the adjustment section 214 notifies the clock master of the synchronization state by means of the sending section of the non-clock master. The receiving section of the clock master receives the notification and passes it to the time detection section 113. The time detection section 113 updates the synchronization state, in accordance with the notification.

<Time Detection Process>

When the time detection section 113 detects the times of the upper clock 111 and the lower clock 121,there should be a correspondence between these two time detection points.

That is to say, in the communication apparatus 100 which is a clock master, it is important to either simultaneously detect the time of the upper clock 111 and the time of the lower clock 121 or detect the time of the lower clock 121 immediately before or after the detection of the time of the upper clock 111.

Also in the communication apparatus 200 which is a non-clock master, the time point at which the time detection section 213 detects the time of the upper clock 211 must correspond to the time point at which the time detection section 213 detects the time of the lower clock 221.

This is because synchronization precision between the upper clock 211 and the upper clock 111 is deteriorated if either (i) the time difference between the time point at which the time detection section 113 detects the time of the upper clock 111 and the time point at which the time detection section 113 detects the time of the lower clock 121 is large or (ii) the difference between the time point at which the time detection section 213 detects the time of the upper clock 211 and the time point at which the time detection section 213 detects the time of the lower clock 221 is large.

For this reason, optimally the time detection section 113 simultaneously detects the times of the upper clock 111 and the lower clock 121 and the time detection section 213 simultaneously detects the times of the upper clock 211 and the lower clock 221. In the following, this process to simultaneously detect two times is termed a time detection process.

In case where the entire system of the communication apparatus 100 and the communication apparatus 200 is designed by a single manufacturer, it is possible to design the system so that two times are simultaneously detected by performing the aforesaid time detection process by hardware.

However, the lower layers 120 and 220 and the upper layers 110 and 210 are typically manufactured by different manufacturers, and hence the layers may not be designed to allow two times to be simultaneously detected, unless the manufacturers share the design. Therefore, in such a case, it is difficult to simultaneously detect two times in the time detection process.

Even in the case above, it is preferable to reduce the time difference between the time points at which the times of the upper clock 111 and the lower clock 121 are detected by the time detection section 113 and to reduce the time difference between the time points at which the times of the upper clock 211 and the lower clock 221 are detected by the time detection section 213.

In the meanwhile, to allow lower layers 120 and 220, which are implemented to a wired LAN card, wireless LAN card or the like, to perform data exchange with upper layers 110 and 210 implemented to the main body of the communication apparatus 100 or 200 or the like, a PCI card interface or an interface equivalent thereto is typically used.

To read out internal registers of lower samplers 122 and 222 of the lower layers 120 and 220 using the aforesaid interface, the time detection sections 113 and 213 of the upper layers 110 and 210 send a reading request to the lower samplers 122 and 222, and then the lower samplers 122 and 222 return information read out from the internal registers, in response to the reading request.

However, since a wired LAN card and a wireless LAN card typically perform various processes, a certain amount of time is required to respond to a request from the time detection sections 113 and 213. Furthermore, a time required to respond to the request may be different each time.

For this reason, in case where the time detection section 113 detects the time of the upper clock 111 and then detects the time of the lower clock 121, a time difference between the time points at which these times are detected changes each time. Synchronization precision between the upper clock 211 and the upper clock 111 is therefore low.

On the other hand, in case where the time of the lower clock 121 is detected first and then the time of the upper clock 11I is detected, since the upper clock 111 and the time detection section 113 are designed in the same upper layer 110, it is easy to reduce the time difference in a period of time from the sending of the request to detect the time of the upper clock 111 to the return of the time to the time detection section 113. On this account, the period of time required to detect the time of the upper clock 111 is always the same.

Therefore, since the time difference between the time points at which the aforesaid two times are detected is always the same, it is possible to improve synchronization precision between the upper clock 211 and the upper clock 111.

Also in the communication apparatus 200 which is a non-clock master, the time detection section 213 detects the time of the lower clock 221 first and then the time of the upper clock 211 is detected, so that synchronization precision between the upper clock 211 and the upper clock 111 is improved.

The time difference between the time point at which the time of the lower clock is detected and the time point at which the time of the upper clock is detected may be fixed (e.g. 5 seconds) all time. However, this approach is disadvantageous in that synchronization precision is not good because the speeds of the lower clock and the upper clock are not constant also in this case.

Assume that, for example the time difference between the time point at which the time of the lower clock is detected and the time point at which the time of the upper clock is detected is 100 ms. Also, in the clock master, it is assumed that the difference between the speeds of the lower clock and the upper clock is 0 ppm at first, and tHTX−tLTX=T1. When the difference between the speeds of the lower clock and the upper clock becomes 20 ppm on account of adjustment, tHTX−tLTX=T1+2 μs. In this manner, jitter of 2 μs occurs. The same holds for the non-clock master.

It is therefore possible to prevent deterioration of synchronization precision by reducing the difference between the time point at which the time of the lower clock is detected and the time point at which the time of the upper clock is detected.

<Steps of Time Adjustment of Upper Clock 211>

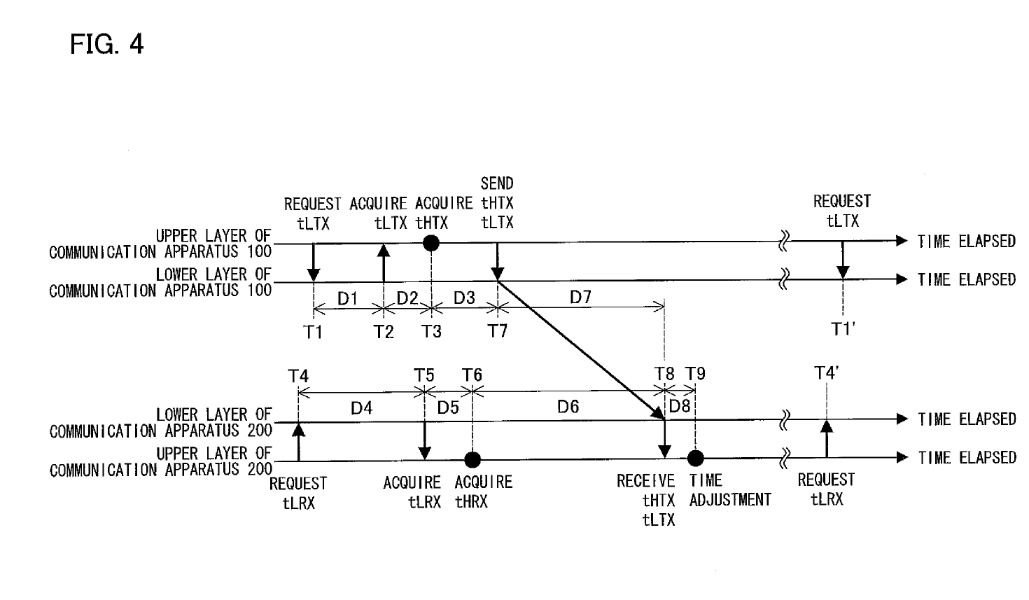

FIG. 4 shows steps of a process in which the adjustment section 214 performs time adjustment of the upper clock 211 as above. The following will describe the steps.

The time detection process on the communication apparatus 100 (clock master) side is as follows: at time point T1, the time detection section 113 first sends, to the lower sampler 122 of the lower layer 120, a request to detect the time tLTX of the lower clock 121.

Thereafter, at time point T2, the lower sampler 122 responds to the request from the time detection section 113 and the time detection 113 acquires the time tLTX at this point.

At time point T3 immediately after the above, the time detection section 113 sends, to the upper sampler 112, a request to detect the time tHTX of the upper clock 111. On this account, the time detection section 113 can acquire the time tHTX at the time point T3 which is substantially the same as the time point T2.

Similarly, the time detection process on the communication apparatus (non-clock master) 200 side is as follows: at time point T4, the time detection section 213 first sends, to the lower sampler 222 of the lower layer 220, a request to figure out the time tLRX of the lower clock 221.

Subsequently, at time point T5, the lower sampler 222 responds to the request from the time detection section 213, so that the time detection section 213 acquires the time tLRX at this point.

At the immediately subsequent time point T6, the time detection section 213 sends, to the upper sampler 212, a request to detect the time tHRX of the upper clock 211. The time detection section 213 can therefore acquire the time tHRX at the time point T6 which is substantially identical with the time point T5.

The time point T1 at which the time detection section 113 sends a request to detect the time tLTX to the lower sampler 122 may precede or be subsequent to the time point T4 at which the time detection section 213 sends a request to detect the time tLRX to the lower sampler 222. T4 may precede T1, or T1 and T4 may be the same.

As to the gap D1 which is the time difference between the time points T1 and T2, an absolute value of D1 may be large as compared to the cycle of requests to detect the time tLTX.

For example, in case where the time interval from the time point T1 at which the time detection section 113 of the communication apparatus 100 sends a request to detect the time tLTX to the time point T1′ at which the time detection section 113 sends a request to detect the time tLTX is 100 ms, D1 may be around several milliseconds. The same holds for D4 which is a time difference between T5 and T4.

In the present example, it is preferable that the gap D2, which is the time difference between T3 and T2, be much shorter than the time difference between T1 and T1′ (100 ms) in several order of magnitudes. This is usually achievable. The same holds for a gap D5 which is a time difference between T6 and T5.

In the sequential diagram in FIG. 4, then at time point T7, the sending section 123 sends, to the communication apparatus 200, the time tHTX and the time tLTX detected by the time detection section 113 of the communication apparatus 100.

Subsequently, at time point T8, the receiving section 223 of the communication apparatus 200 receives the time tHTX and the time tLTX supplied from the communication apparatus 100.

Subsequently, at time point T9, the adjustment section 214 performs the calculation indicated by the equation (1) or (2) by using the times tHRX and tLRX detected by the time detection section 213 and the times tHTX and tLTX received by the receiving section 223. Based on the result of the calculation, the adjustment section 214 performs PLL adjustment, i.e. adjusts the upper clock 211.

<Timing of Time Detection Process in Each of Communication apparatuses 100 and 200>

The objective of the present embodiment is to achieve synchronization between the upper clocks 111 and 211 with the assumption that the lower clocks 121 and 221 are synchronized with one another. Therefore, as in the example shown in FIG. 9, the upper clocks 111 and 211 are synchronized with one another and the lower clocks 121 and 221 are synchronized with one another whereas the lower clock 121 and the upper clock 111 are typically not synchronized with one another and the lower clock 221 and the upper clock 211 are typically not synchronized with one another.

On this account, the gap between the times of the lower clock 121 and the upper clock 111 and the gap between the times of the lower clock 221 and the upper clock 211 increase as time elapses.

For example, in case where the lower clock 121 is a clock master of the lower layer and the difference in precision of the lower clock 121 and the upper clock 111 is 20 ppm, the gap between the times of the lower clock 121 and the upper clock 111 increases by 0.2 μs in each 10 ms. Since the lower clock 221 and the upper clock 211 are non-clock masters, the gap between the times of the lower clock 221 and the upper clock 211 is also 20 ppm on average over the long term.

While the times of an upper clock which is a clock master and an upper clock which is a non-clock master arc simultaneously detected in the conventional method, in the present invention the times tHTX and tHRX of the upper clocks 111 and 211 are not simultaneously detected. However, since the time tLTX of the lower clock 121 and the time tLRX of the lower clock 221 are reflected, it is possible to acquire a result substantially identical with the case where the times tHTX and tHRX are simultaneously detected.

However, since the lower clocks 121 and 221 and the upper clocks 111 and 211 are different from one another in terms of precision as discussed above, an error in information used for adjustment of the upper clock 211 is significant and synchronization precision is low, if the difference between the time point at which times tLTX and tHTX are detected, and the time point at which the times tLRX and tHRX are detected is too large.

For example, in case where a difference in precision between the lower clock 121 and the upper clock 111 is 20 ppm and tLRX−tLTX=10 ms, tHRX−tHTX equals to 10 ms+0.2 μs and hence an error of 0.2 μs is added. In case where tLRX−tLTX=30 ms, tHRX−tHTX equals to 30 ms+0.6 μs and hence an error of 0.6 μs is added.

Therefore, since PLL for the upper clock 211 is adjusted by PLL adjustment value tHRX−tHTX−(tLRX−tLTX), the synchronization precision of the upper clock 211 is improved by reducing tLRX−tLTX.

In other words, to prevent deterioration in synchronization precision, it is preferable to reduce the time difference between T1 at which a request to detect the time tLTX is made and T4 at which a request to detect the time tLRX is made.

Still, it is preferable that T1′−T1, i.e. the time period after the time detection process and before the next time detection process in the communication apparatus 100, be longer than the time period required to execute the time detection process in the communication apparatus 100, then to supply the detected time information to the communication apparatus 200, and finally to adjust the upper clock 211 in the communication apparatus 200.

To reduce the time difference between T1 and T4, the time points T1 (T1′) and T4 (T4′) at which the communication apparatuses 100 and 200 start the time detection process are predetermined by the time detection section 113 of the communication apparatus 100 and the time detection section 213 of the communication apparatus 200. To predetermine the time points, for example, the time detection process is periodically performed at certain intervals, so that the time point at which the time detection process starts can be easily controlled.

It is, however, noted that reduction in the difference between T1 and T4 does not indicate that the times tHTX and tLTX are simultaneously detected. This is because gaps D1 and D4 are much larger than the synchronization precision.

<How Time Detection Sections 113 and 213 Recognize Predetermined Times>

Provided that the time detection sections 113 and 213 are implemented by hardware and the upper clocks 111 and 211 are directly connected with the time detection sections 113 and 213, the time detection sections 113 and 213 can directly receive signals from the upper clocks 111 and 211. In other words, the time detection sections 113 and 213 can always grasp the times of the upper clocks 111 and 211.

In this case, the time detection sections 113 and 213 can recognize with no delay when is the predetermined time, i.e. the time to request the detection of tLTX or tLRX.

In the meanwhile, in case where the time detection sections 113 and 213 are implemented by software, since the time detection sections 113 and 213 which are functional blocks realized by software are not directly connected to the upper clocks 111 and 211 which are hardware, the time detection sections 113 and 213 cannot always recognize the times of the upper clocks 111 and 211.

In the case above, even if the time at which the next request to detect the time tLTX or tLRX is predetermined, the time detection sections 113 and 213 cannot recognize without delay when the predetermined time comes. On this account, the time detection sections 113 and 213 need to recognize when the time comes, by means of another method.

The time may be recognizable by using a clock of the OS. The clock of the OS may be the upper clock 111 or 221, the lower clock 121 or 221, or another clock. The upper clocks 111 and 211 are preferably used as the clock of the OS by which the predetermined time is recognized as a reference, because the upper clocks 111 and 211 are on the same upper layers 110 and 210 as the time detection sections 113 and 213.

In case where the time detection process by the time detection sections 113 and 213 is performed by software as above, there are several ways to allow the time detection section to recognize that the clock of the OS has reached the predetermined time. Details thereof will be given later.

Since the OS is likely to simultaneously perform several processes, it is not possible to precisely send a request to detect the time tLTX or tLRX at the predetermined time point, unless the OS is a real-time OS. When the process is performed by software, actual start of the process lags behind the predetermined time by several milliseconds.

There is an OS which can wait a predetermined time period, i.e. has a timer interrupt function. When the timer interrupt function is available, the time detection sections 113 and 213 calculate a waiting time from the time point at which the last time detection process was performed to the time point at which a request to detect the time tLTX or tLRX will be made, and the detection sections 113 and 213 perform the time detection process after the waiting period has elapsed.

For example, in case where the time detection sections 113 and 213 use the upper clocks 111 and 211 as references to recognize the time to send a request of detecting the time tLTX or tLRX, the waiting period from the detection of the time tHTX or tHRX to the request to detect the next time tLTX or tLRX is calculated with reference to the times of the upper clocks 111 and 211.

On the other hand, if the OS is not provided with a timer interrupt function, the time of a clock can be, for example, set as a reference and regularly detected. The request to detect the time tLTX or tLRX is then made if the detected time of the clock is equal to or later than the time at which the request is to be performed.

<Specific Examples of Values Such as Gaps>

Examples of specific values will be given. To achieve synchronization precision of around several hundred of nano seconds in case where the cycle of synchronization is around several hundreds of milliseconds, gaps and the like are preferably restrained as below.

Jitter between T1 and T4: less than 10 milliseconds

Gap between D1 and D4: less than 10 milliseconds

Gap between D2 and D5: less than several microseconds

The Jitter indicates a gap between (i) a predetermined time point at which a request to detect the time tLTX or tLRX is to be made and (ii) time point at which the request is actually made.

These three conditions are easily achievable at the current technical level.

If the values above are satisfied, a time difference between the time point (T2=T1+D1) at which the time tLTX is acquired and the time point (T5=T4+D4) at which the time tLRX is acquired is restrained to be not longer than 20 ms.

The lower clock 121 and the upper clock 111, or the lower clock 221 and the upper clock 211, are not synchronized with one another. In case where a difference in precision of clocks of these layers is 20 ppm, an error (gap) in precision of the lower clocks 121 and 221 and the upper clocks 111 and 211 is not longer than 0.4 μs if the time difference between T2 and T5 is not longer than 20 ms. The gap of several microseconds between D2 and D5 and an error between the times of the upper clocks 11 and 211 are added to the gap of not longer than 0.4 μs, and the resulting error is input for PLL adjustment. PLL reduces this error, with the result that the error between the times of the upper clocks 111 and 211 is restrained to around several hundred nanoseconds.

### Second Embodiment

The following will describe an embodiment of the present invention with reference to figures. The present embodiment only deals with those different from the first embodiment.

<Communication System 400b>

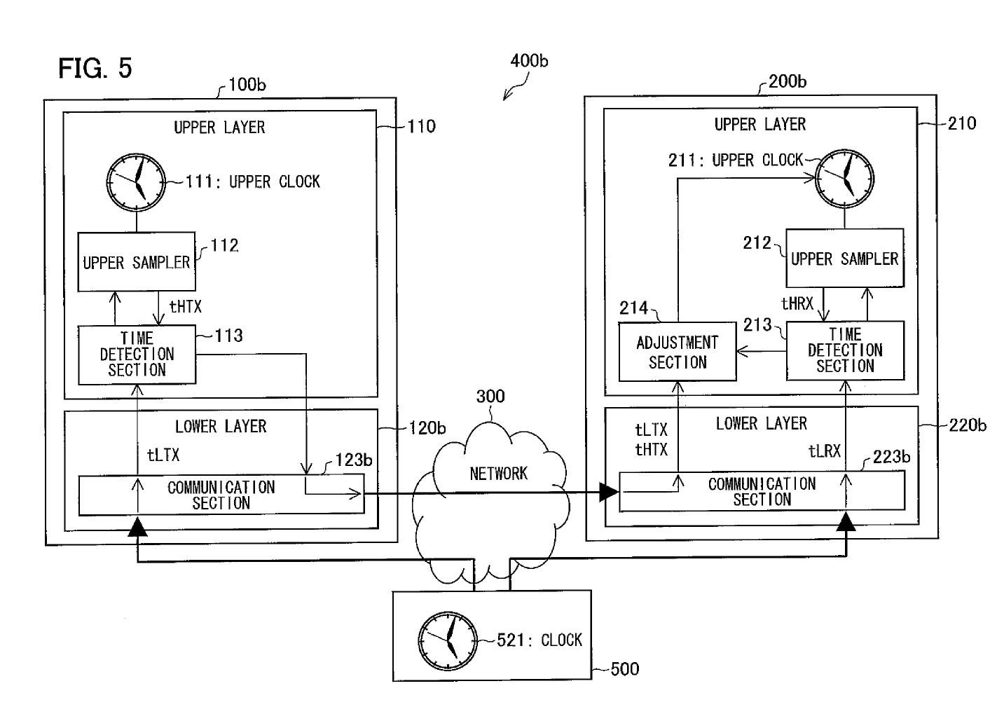

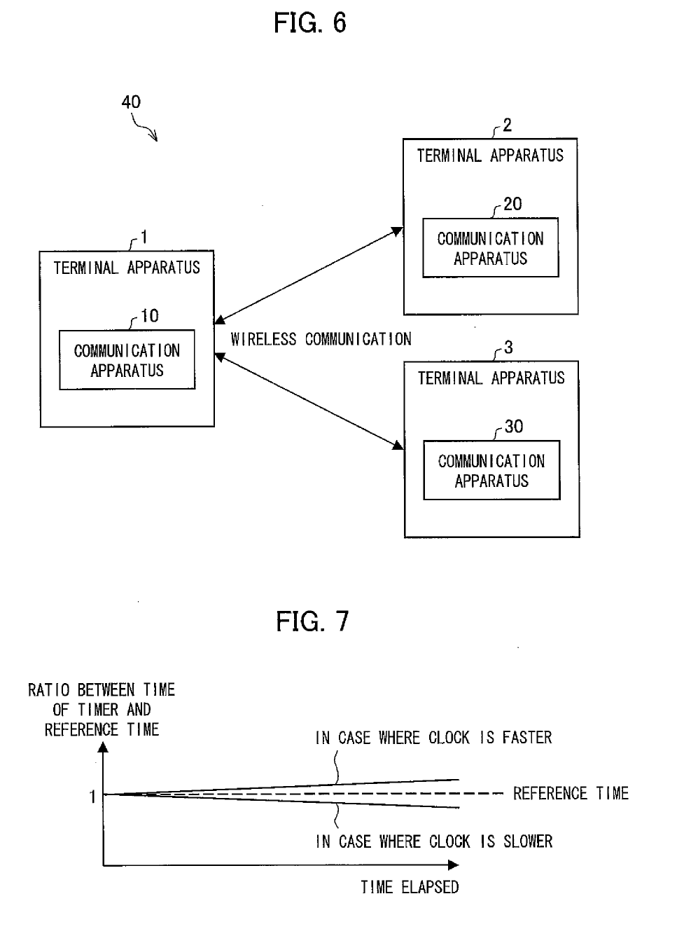

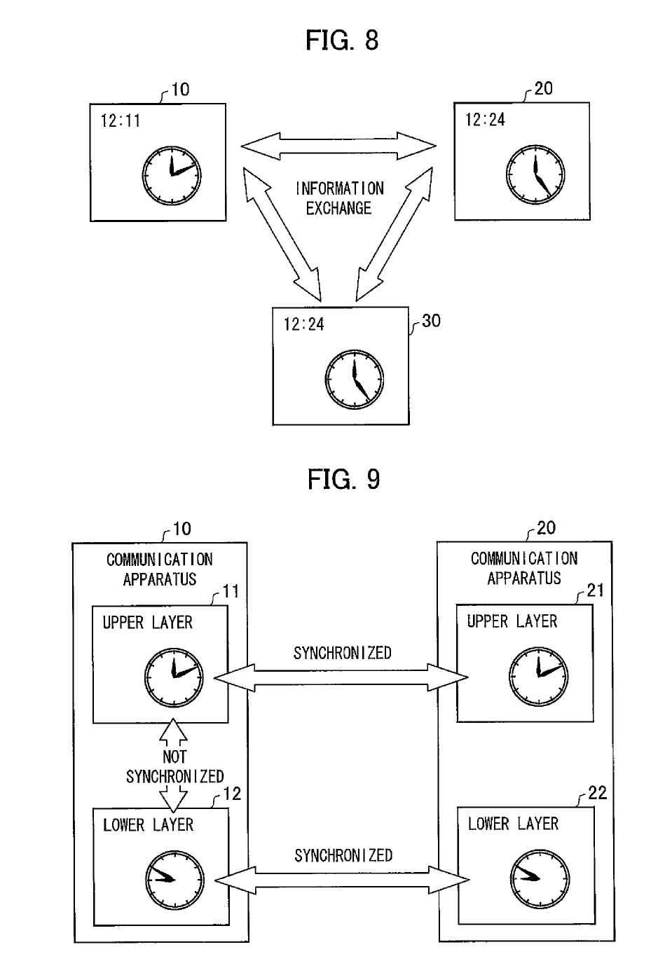

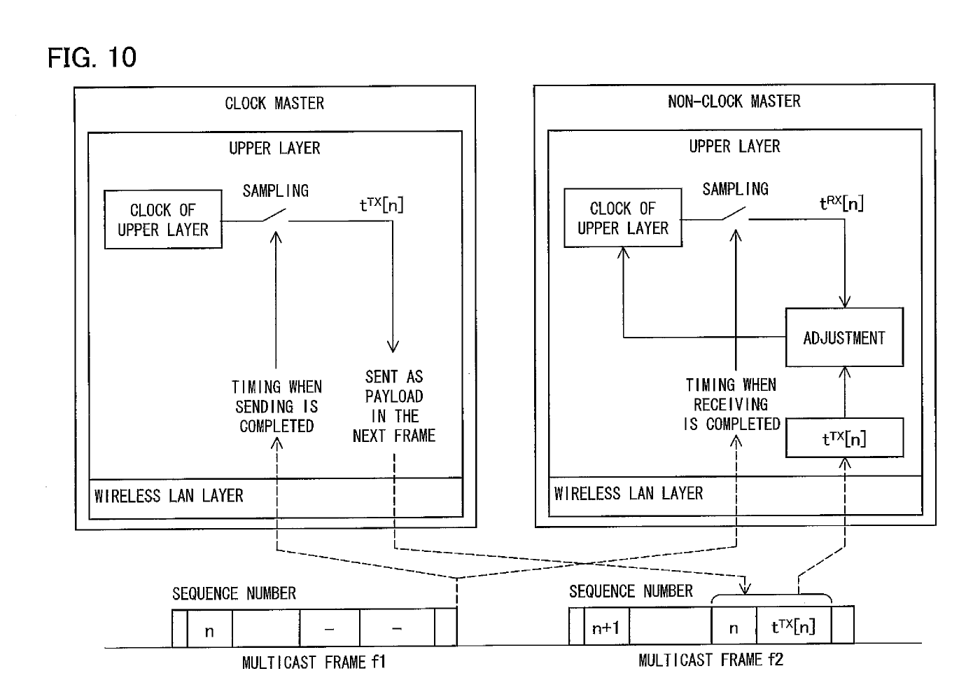

FIG. 5 outlines a communication system 400b of the present embodiment. The communication system 400b includes a communication apparatus 100b, a communication apparatus 200b, and a communication apparatus 500. The communication apparatus 100b, communication apparatus 200b, and communication apparatus 500 are connected so as to be able to communicate with one another, over a network 300.

In the first embodiment, the reference time is provided by the lower clocks 121 and 221. In the present embodiment, the communication apparatus 500 provides a reference time by sending it to the communication apparatuses 100b and 200b.

The reference time supplied from the communication apparatus 500 is regarded as time tLTX when received by the communication section 123b, or regarded as time tLRX when received by the communication section 223b. These reference times are both acquired by detecting the clock 521 (external clock) in the communication apparatus 500.

The communication apparatus 500 is, for example, a time server provided in a sender of radio waves for wave clocks or a time server provided in a GPS satellite sending GPS signals. A transmission method by which the communication apparatus 500 communicates with the communication apparatuses 100b and 200b is not necessarily identical with a transmission method by which the communication apparatus 100b and the communication apparatus 200b communicate with one another.

Therefore, for example, if the communication apparatuses 100b and 200b communicate with one another by a wired LAN or wireless LAN, these apparatuses can perform high-speed data exchange. For this reason, in the present embodiment, a transmission method by which the communication apparatus 500 communicates with the communication apparatuses 100b and 200b is different from a transmission method by which the communication apparatus 100b and the communication apparatus 200b communicate with one another.

In case where the method by which the communication apparatus 500 communicates with the communication apparatuses 100b and 200b is broadcasting or multicasting, the time tLTX and the time tLRX may have the same value.

<Acquisition of Reference Time from Communication apparatus 500>

The communication apparatuses 100b and 200b both perform communications by the lower layers 120b and 220b and the upper layers 110 and 210.

The upper layer 110 of the communication apparatus 100b is provided with an upper clock 111, a time detection section 113, and an upper sampler 112, whereas the lower layer 120b is provided with a communication section 123b (sending means).

The upper layer 210 of the communication apparatus 200b is provided with an upper clock 211, a time detection section 213, an upper sampler 212, and an adjustment section 214, whereas the lower layer 220b is provided with a communication section 223b (receiving means).

The time detection section 113 of the communication apparatus 100b detects both the time tHTX of the upper clock 111 and the time tLTX supplied from the communication apparatus 500. The detected times are, as detected time information, supplied to the communication apparatus 200b via the communication section 123b. The reference time supplied from the communication apparatus 500 is received by the communication section 123b and transferred to the time detection section 113. When the time detection section 113 detects the time of the upper clock 111, first a request is supplied to the upper sampler 112. Then the upper sampler 112 samples the time of the upper clock 111 and sends the time tHTX to the time detection section 113.

The time detection section 213 of the communication apparatus 200b detects both the time tHRX of the upper clock 211 and the time tLRX supplied from the communication apparatus 500. The communication section 223b receives the detected time information from the communication apparatus 100b, and sends the same to the adjustment section 214. Using the supplied time information, the adjustment section 214 adjusts the time of the upper clock 211. The reference time is supplied from the communication apparatus 500 to the communication section 223b, and is transferred to the time detection section 213, as time tLRX. When the time detection section 213 detects the time of the upper clock 211, first a request is sent to the upper sampler 212. The upper sampler 212 samples the time of the upper clock 211, and sends the time tLRX to the time detection section 213.

<Additional Notes>

The present invention is not limited to the description of the embodiments above, but may be altered by a skilled person within the scope of the claims. An embodiment based on a proper combination of technical means disclosed in different embodiments is encompassed in the technical scope of the present invention.

The blocks in the communication apparatus 100 and 200, the time detection sections 113 and 213 and the adjustment section 214 in particular, may be realized by hardware logic. Alternatively, the blocks may be realized by software, with the use of a CPU as follows.

That is, the communication apparatuses 100, 200, 100b, and 200b may include members such as: a CPU (Central Processing Unit) that executes instructions of a control program realizing the functions; a ROM (Read Only Memory) recording the program; a RAM (Random Access Memory) on which the program is executed; and a storage device (recording medium) such as a memory, which stores the program and various kinds of data. The objective of the present invention can be achieved in the following manner: program code (e.g. an executable code program, intermediate code program, and source program) of the control program of the communication apparatuses 100, 200, 100b, and 200b, the control program being software for realizing the functions, is recorded on a recording medium in a computer-readable manner, this recording medium is supplied to the communication apparatuses 100, 200, 100b, and 200b, and the computer (or CPU or MPU) reads out the program code from the recording medium and execute the program.

Examples of such a recording medium include a tape, such as a magnetic tape and a cassette tape; a magnetic disk, such as a flexible disk and a hard disk; a disc including an optical disc, such as a CD-ROM/MO/MD/DVD/CD-R; a card, such as an IC card (inclusive of a memory card); and a semiconductor memory, such as a mask ROM, an EPROM (Erasable Programmable Read Only Memory), an EEPROM (Electrically Erasable Programmable Read Only Memory), or a flash ROM.

Alternatively, the communication apparatuses 100, 200, 100b, and 200b may be capable of being connected to a communication network, allowing the program code to be supplied via the communication network. Non-limiting examples of the communication network include the Internet, intranet, extranet, LAN, ISDN, VAN CATV network, virtual private network, telephone network, mobile communication network, and satellite communication network. Non-limiting examples of the transmission media composing the communication network are, wired media such as IEEE1394, USB, power line communication, cable TV lines, telephone lines, and ADSL lines, infrared light such as IrDA and remote controller, electric waves such as Bluetooth®, IEEE802.11, HDR, mobile telephone network, satellite connection, and terrestrial digital broadcasting network. It is also noted the present invention may be realized by a carrier wave or as data signal sequence, which are realized by electronic transmission of the program code.

(A) To achieve the objective above, the communication apparatus of an embodiment of the present invention, which is a clock master, includes: a first apparatus time clocking section for clocking a first apparatus time of the communication apparatus; a first time detection section for executing a time detection process to detect, substantially at the same time, the first apparatus time and a first reference time synchronized with a second reference time referred to by a non-clock master; and a sending section for sending, to the non-clock master, the detected first apparatus time and first reference time.

To achieve the objective above, the communication apparatus of an embodiment of the present invention, which is a non-clock master and synchronizes a first apparatus time of a clock master with a second apparatus time of the communication apparatus, includes: a second apparatus time clocking section for clocking the second apparatus time; a second time detection section for performing a time detection process to detect, substantially at the same time, the second apparatus time and a second reference time synchronized with a first reference time referred to by the clock master; a receiving section for receiving the first apparatus time and the first reference time from the clock master; and a time adjustment section for adjusting the second apparatus time, with reference to the detected second apparatus time, the detected second reference time, the received first apparatus time, and the received first reference time.

To achieve the objective above, a communication system of an embodiment of the present invention includes: a communication apparatus which is a clock master; and a communication apparatus which is a non-clock master, the communication apparatus as the clock master including: a first apparatus time clocking section for clocking a first apparatus time of the clock master; a first time detection section for executing a time detection process to detect, substantially at the same time, the first apparatus time and a first reference time synchronized with a second reference time referred to by the non-clock master; and a sending section for sending, to the non-clock master, the detected first apparatus time and first reference time, the communication apparatus as the non-clock master, which synchronizes the first apparatus time of the clock master with the second apparatus time of the non-clock master, including: a second apparatus time clocking section for clocking the second apparatus time; a second time detection section for performing a time detection process to detect, substantially at the same time, the second apparatus time and the second reference time synchronized with the first reference time referred to by the clock master; a receiving section for receiving the first apparatus time and the first reference time from the clock master; and a time adjustment section for adjusting the second apparatus time, with reference to the detected second apparatus time, the detected second reference time, the received first apparatus time, and the received first reference time.

To achieve the objective above, a synchronization method of an embodiment of the present invention, for synchronizing a first apparatus time of a clock master with a second apparatus time of a non-clock master, includes the steps, executed by a communication apparatus as the clock master, of: clocking the first apparatus time; detecting, substantially at the same time, the first apparatus time and a first reference time which is synchronized with a second reference time referred to by the non-clock master; and sending the detected first apparatus time and first reference time to the non-clock master, the method further including the steps, executed by a communication apparatus as the non-clock master, of: clocking the second apparatus time; detecting, substantially at the same time, the second apparatus time and the second reference time; receiving the first apparatus time and the first reference time; and adjusting the second apparatus time with reference to the detected second apparatus time, the detected second reference time, the received first apparatus time, and the first reference time.

The clock master is constituted by a first apparatus time clocking section, a first time detection section, and a sending section. The first time detection section detects, substantially at the same time, the first apparatus time and the first reference time. The first time detection section sends both of the detected times to a non-clock master, via the sending section.

The non-clock master is constituted by a second apparatus time clocking section, a second time detection section, a receiving section, and a time adjustment section. The second time detection section detects, substantially at the same time, the second reference time and the second apparatus time clocked by the second apparatus time clocking section. The receiving section receives the first apparatus time and first reference time supplied from the clock master.

The term “substantially at the same time” includes the following two cases: the first apparatus time and the first reference time are completely simultaneously detected; and there is a small gap between the time point at which one of the times is detected and the time point at which the other time is detected.

According to the aforesaid arrangements and method, the time adjustment section adjusts the time of the second apparatus time clocking section, with reference to the received first apparatus time, the received first reference time, the detected second apparatus time, and the detected second reference time. It is noted that the first reference time and the second reference time are synchronized with one another.

In the arrangement, the timing at which the first reference time is detected is arranged to correspond to the timing at which the first apparatus time is detected, whereas the timing at which the second reference time is detected is arranged to correspond to the timing at which the second apparatus time is detected.

Optimally the timing at which the first reference time is detected is identical with the timing at which the first apparatus time is detected. However, a little gap may occur in some type of systems.

A time difference between the timing to detect the first apparatus time and the timing to detect the second apparatus time is close to a time difference TD between the timing to detect the first reference time and the timing to detect the second reference time.

The first apparatus time and the second apparatus time are therefore not simultaneously detected. However, by reflecting the time difference TD to the detected first and second apparatus times, it is possible to acquire an effect similar to the effect of the conventional art taught in the patent document 1, in which the first and second apparatus times are simultaneously detected.

According to the arrangement above, synchronization between the first and second apparatus times is achieved by using a difference between the second reference time and the first reference time. Therefore, being different from the conventional art, it is unnecessary to simultaneously detect the first and second apparatus times.

Since it is unnecessary to simultaneously detect the first and second apparatus times, a multicast frame used for simultaneous sampling in the synchronization taught by the conventional art is unnecessary.

Also, since a multicast frame is not required, in other words, since a frame to send the first apparatus time and the first reference time from the clock master to the non-clock master is not required to be a multicast frame, the first apparatus time and the first reference time can be transmitted by a uni-cast frame, even if the transmission is performed based on IEEE802.11e.

That is, being different from the convention art in which transmission is performed in two steps through the intermediary of an AP, transmission is performed in a single step without the intermediary of an AP. On this account, in case where there is a single non-clock master, the synchronization method of the present invention requires a smaller bandwidth in a wireless LAN conforming to IEEE802.11e.

(B) In addition to the above, the communication apparatus of the present invention is arranged such that the time adjustment section adjusts the second apparatus time clocking section by an adjustment value figured out by:

adjustment value=(second apparatus time−first apparatus time)−(second reference time−first reference time).

According to this arrangement, the time adjustment section acquires four sets of time information, i.e. the first apparatus time, the second apparatus time, the first reference time, and the second reference time. On this account, the adjustment of the second apparatus time clocking section can be performed by an adjustment value uniquely determined by the equation above.

(C) In addition to the above, the communication apparatus of the present invention is arranged such that if a gap between the first apparatus time and the second apparatus time is larger than a predetermined value, the time adjustment section sets a current time of the second apparatus time clocking section to be identical with the received first apparatus time, whereas if the gap is not larger than the predetermined value, the time adjustment section determines to what extent clocking speed of the second apparatus time clocking section is increased or decreased, in accordance with the degree of the gap.

According to this arrangement, the time adjustment section judges that synchronization between the clock master and the non-clock master is out if the gap between the first and second apparatus times is larger than a predetermined value, and instructs the clock master to send the first apparatus time and the first reference time. The time adjustment section figures out the current correct time of the second apparatus time clocking section with reference to the received first reference time and first apparatus time, and directly set the second apparatus time clocking section at the time thus figured out.

The time adjustment section judges that the clock master and the non-clock master are synchronized with one another if a gap between the first and second apparatus times is not larger than the predetermined value, and instructs the clock master to send a difference between the detected first reference time and first apparatus time. Using the supplied difference, the time adjustment section fine-tunes the speed of the second apparatus time clocking section.

According to the arrangement above, when synchronization between the first and second apparatus times is out, the second apparatus time clocking section is directly set at the first apparatus time, and hence synchronization is quickly achieved.

Furthermore, when the first and second apparatus times are synchronized with one another, it is possible to keep the synchronization by fine-tuning the speed of the second apparatus time clocking section.

(D) In addition to the above, the communication apparatus of the present invention is arranged such that a first reference time clocking section for clocking the first reference time is provided and the first time detection section detects the first reference time from the first reference time clocking section, and a second reference time clocking section for clocking the second reference time is provided and the second time detection section detects the second reference time from the second reference time clocking section.

According to this arrangement, to cause the non-clock master to be synchronized with the clock master by means to the synchronization technique of the present invention, it is necessary that the first reference time clocking section of the clock master is synchronized with the second reference time clocking section of the non-clock master. The wireless LAN, PLC, or Ethernet® standard, which functions as a lower layer, defines that respective terminals have synchronized clocks. Therefore, Provided that the first apparatus time clocking section and the second apparatus time clocking section are clocks of the upper layer, the clocks defined in the standard of the lower layer can be used as the first reference time clocking section and the second reference time clocking section.

In this case, since the first time detection section detecting the first reference time and the first apparatus time and the second time detection section detecting the second reference time and the second apparatus time are provided in the same upper layer as the first and second apparatus time clocking sections, a function to detect the times of the first and second reference time clocking sections from the upper layer is required. The first and second reference times can be typically referred to from the upper layer via, for example, PCI (Peripheral Component Interconnect) bus. It is therefore unnecessary to provide a new function in the lower layer, according to the synchronization method of the present invention.

In the meanwhile, in the conventional art, it is necessary to provide a function to cause the lower layer to recognize a special multicast frame for synchronization and notifies the upper layer of the time when the last part of the frame is sent or received. A standard technology supporting this function is defined in IEEE802.11e, but there seems not many types of wireless LAN chip sets having this function, because the function is optional in the standard.

According to the arrangement above, since it is unnecessary to provide a new function in the lower layer, it is possible to adopt many types of standards to the lower layer, such as wireless LAN, PLC, and Ethernet.

(E) In addition to the above, the communication apparatus of the present invention is arranged such that the sending section sends the first reference time and the first apparatus time to the non-clock master if the gap between the first and second apparatus times is larger than a predetermined value, and the sending section sends a difference between the first reference time and the first apparatus time to the non-clock master if the gap between the first and second apparatus times is not larger than the predetermined value. If the gap between the first and second apparatus times is larger than the predetermined value, the receiving section receives the first reference time and the first apparatus time from the clock master, whereas, if the gap between the first and second apparatus times is not larger than the predetermined value, the receiving section receives the difference between the first reference time and the first apparatus time from the clock master.

According to this arrangement, the time adjustment section judges that synchronization between the clock master and the non-clock master is out if the gap between the first and second apparatus times is larger than the predetermined value, and instructs the clock master to send the first apparatus time and the first reference time via the sending section. The time adjustment section figures out the current correct time of the second apparatus time clocking section with reference to the first reference time and the first apparatus time supplied via the receiving section, and directly sets the second apparatus time clocking section at the current time thus figured out.

The time adjustment section judges that the clock master and the non-clock master are synchronized with one another if the gap between the first apparatus time and the second apparatus time is not larger than the predetermined value, and instructs the clock master to send a difference between the detected first reference time and first apparatus time, via the sending section. The time adjustment section fine-tunes the speed of the second apparatus time clocking section by using the difference received via the receiving section.

According to this arrangement, when the synchronization is achieved, information to be sent is a difference between the first reference time and the first apparatus time. It is therefore possible to reduce an amount of information to be sent.

(F) In addition to the above, the communication apparatus of the present invention is arranged such that the first time detection section detects the first apparatus time after detecting the first reference time. Also, the second time detection section detects the second apparatus time after detecting the second reference time.

According to the arrangement, the first time detection section detects the first apparatus time from the first apparatus time clocking section in the upper layer, and detects the first reference time from the lower layer. The second time detection section detects the second apparatus time from the second apparatus time clocking section in the upper layer, and detects the second reference time from the lower layer. However, for example, in case where the upper layer and the lower layer are implemented by different types of hardware (different chips), the first time detection section in the upper layer detects the first reference information on the other chip via the PCI bus connecting the chips, whereas the second time detection section in the upper layer detects the second reference information on the other chip, via the PCI bus connecting the chips. In such a case, the detections of the first and second reference times, which take time and the times required therefor are inconsistent, are performed prior to the detections of the first and second apparatus times, which do not take time and times required therefor are consistent.

According to the arrangement above, immediately after the inconsistent and time-consuming detection of the first reference time, the consistent and speedy detection of the first apparatus time is performed, whereas immediately after the inconsistent and time-consuming detection of the second reference time, the consistent and speedy detection of the second apparatus time is performed. This is advantageous in that a gap between the detection of the reference time and the detection of the apparatus time is reduced and a fluctuation in the gap is prevented.

(G) In addition to the above, the communication apparatus of the present invention is arranged such that the first time detection section performs the time detection process at the predetermined process execution schedule time. The second time detection section performs the time detection process at the predetermined process execution schedule time.

According to this arrangement, in the clock master and the non-clock master, the process execution schedule time is determined in advance in order to perform the time detection processes at the same time. The adjustment of the second apparatus time clocking section is performed by using the value figured out by (second apparatus time−first apparatus time)−(second reference time−first reference time). On this account, when the time detection processes are executed at the same time, the value in the term (second reference time—first reference time) is reduced and hence an error factor is reduced.

According to the arrangement above, in the clock master and the non-clock master, the time detection processes are simultaneously performed at the predetermined time, and hence an error factor is reduced. It is therefore possible to improve the precision in synchronization between the clock master and the non-clock master.

(H) In addition to the above, the communication apparatus of the present invention is arranged such that the time detection process is regularly performed at the periodical process execution schedule times.

According to this arrangement, the time detection process is periodically performed at, for example, regular intervals.

According to this arrangement, the time detection process is started in accordance with predetermined intervals. It is therefore possible to easily control the process execution schedule time at which the time detection process is started.

(I) In addition to the above, the communication apparatus of the present invention is arranged such that, after performing the time detection process, the first time detection section figures out the process execution schedule time at which the time detection process is executed next, with reference to (i) a waiting period from the time detection process to the next time detection process and (ii) a time at which the time detection process is performed last time. Also, after performing the time detection process, the second time detection section figures out the process execution schedule time at which the time detection process is executed next, with reference to (i) a waiting period from the time detection process to the next time detection process and (ii) a time at which the time detection process is performed last time.

According to the arrangement above, the process execution schedule time at which the time detection process is performed next is figured out by adding the waiting period to the time at which the time detection process is performed last time. It is therefore possible to easily determine when the next time detection process is to be performed.

(J) In addition to the above, the communication apparatus of the present invention is arranged such that the first time detection section regularly figures out the first apparatus time, the first reference time, or another time information, and executes the time detection process if the time thus figured out is equal to or later than the process execution schedule time. Also, the second time detection section regularly figures out the second apparatus time, the second reference time, or another time information, and executes the time detection process if the time thus figured out is equal to or later than the process execution schedule time.

According to this arrangement, the time detection section performs the time detection process when the predetermined process execution schedule time comes.

According to the arrangement above, the time is regularly figured out even if a function to wait a time specified by the OS (Operating System). It is therefore possible to determine the process execution schedule time at which the next time detection process is performed.

(K) In addition to the above, the communication system of the present invention is arranged such that the first reference time and the second reference time are indicated by a single external clock.

According to this arrangement, since time information transmitted by a synchronization method of an wave clock or GPS can be set as first and second reference times, it is possible to synchronize the communication apparatuses by using the time information of a clock outside the communication apparatuses.

(L) The communication apparatus may be realized by hardware or by causing a computer to execute a program. More specifically, a program of the present invention is a communication apparatus control program causing a computer to function as at least the first and second time detection sections and time adjustment section, and a storage medium of the present invention stores the communication apparatus control program.

A computer executes the communication apparatus control program so that the computer functions as the communication apparatus. Therefore, in the same matter as the communication apparatus above, synchronization between the first and second apparatus times is achieved by using a gap between the second reference time and the first reference time. For this reason, being different from the conventional art, it is unnecessary to detect the first and second apparatus times at the same time. Since it is unnecessary to detect the first and second apparatus times at the same time, a multicast frame used for simultaneous sampling in the synchronization method of the conventional art is unnecessary. Furthermore, being different from the conventional art in which transmission is performed in two steps by using AP, transmission is performed in a single step without AP. On this account, in case where there is a single non-clock master, synchronization method of the present invention requires a smaller bandwidth in a wireless LAN conforming to IEEE802.11e.

As discussed above, a communication apparatus of the present invention includes: a first apparatus time clocking section for clocking a first apparatus time which is the time of the communication apparatus; a first time detection section for executing a time detection process to detect, substantially at the same time, the first apparatus time and a first reference time synchronized with a second reference time referred to by a non-clock master; and a sending section for sending, to the non-clock master, the detected first apparatus time and first reference time.

As discussed above, a communication apparatus of the present invention includes: a second apparatus time clocking section for clocking the second apparatus time; a second time detection section for performing a time detection process to detect, substantially at the same time, the second apparatus time and a second reference time synchronized with a first reference time referred to by the clock master; a receiving section for receiving the first apparatus time and the first reference time from the clock master; and a time adjustment section for adjusting the second apparatus time, with reference to the detected second apparatus time, the detected second reference time, the received first apparatus time, and the received first reference time.

As discussed above, a communication system of the present invention, includes: a communication apparatus which is a clock master; and a communication apparatus which is a non-clock master, the communication apparatus as the clock master including: a first apparatus time clocking section for clocking a first apparatus time of the clock master; a first time detection section for executing a time detection process to detect, substantially at the same time, the first apparatus time and a first reference time synchronized with a second reference time referred to by the non-clock master; and a sending section for sending, to the non-clock master, the detected first apparatus time and first reference time, the communication apparatus as the non-clock master, which synchronizes the first apparatus time of the clock master with the second apparatus time of the non-clock master, including: a second apparatus time clocking section for clocking the second apparatus time; a second time detection section for performing a time detection process to detect, substantially at the same time, the second apparatus time and the second reference time synchronized with the first reference time referred to by the clock master; a receiving section for receiving the first apparatus time and the first reference time from the clock master; and a time adjustment section for adjusting the second apparatus time, with reference to the detected second apparatus time, the detected second reference time, the received first apparatus time, and the received first reference time.

As discussed above, a synchronization method of a communication apparatus of the present invention, for synchronizing a first apparatus time of a clock master with a second apparatus time of a non-clock master, the method comprising the steps, executed by a communication apparatus as the clock master, of: clocking the first apparatus time; detecting, substantially at the same time, the first apparatus time and a first reference time which is synchronized with a second reference time referred to by the non-clock master; and sending the detected first apparatus time and first reference time to the non-clock master, the method further comprising the steps, executed by a communication apparatus as the non-clock master, of: clocking the second apparatus time; detecting, substantially at the same time, the second apparatus time and the second reference time; receiving the first apparatus time and the first reference time; and adjusting the second apparatus time with reference to the detected second apparatus time, the detected second reference time, the received first apparatus time, and the first reference time.

Therefore, synchronization between the first and second apparatus times is achieved by using a gap between the second reference time and the first reference time. For this reason, being different from the conventional art, it is unnecessary to detect the first and second apparatus times at the same time. Since it is unnecessary to detect the first and second apparatus times at the same time, a multicast frame used for simultaneous sampling in the synchronization method of the conventional art is unnecessary. Furthermore, being different from the conventional art in which transmission is performed in two steps by using AP, transmission is performed in a single step without AP. On this account, in case where there is a single non-clock master, synchronization method of the present invention requires a smaller bandwidth in a wireless LAN conforming to IEEE802.11e.

According to the present invention, plural communication apparatuses which communicate with one another in a communication system can synchronize respective apparatus times, without performing time detections in the respective communication apparatuses. The present invention can therefore be suitably used for audio equipments, television receivers, home theaters, and projectors.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A communication apparatus which is a clock master, comprising:
first apparatus time clocking means for clocking a first apparatus time of the communication apparatus;
first time detection means for executing a time detection process to detect, substantially at the same time, the first apparatus time and a first reference time synchronized with a second reference time referred to by a non-clock master; and
sending means for sending, to the non-clock master, the detected first apparatus time and first reference time.

2. The communication apparatus as defined in claim 1, further comprising first reference time clocking means for clocking the first reference time,
the first time detection means detecting the first reference time from the first reference time clocking means.

3. The communication apparatus as defined in claim 1,
wherein, the first time detection means detects the first apparatus time after detecting the first reference time.

4. The communication apparatus as defined in claim 1,
wherein, the first time detection means executes the time detection process at a predetermined process execution schedule time.

5. The communication apparatus as defined in claim 4,
wherein, the time detection process is executed at periodical process execution schedule times.

6. The communication apparatus as defined in claim 4,
wherein, the first time detection means figures out the process execution schedule time at which the time detection process is executed next, with reference to (i) a waiting period from the time detection process to the next time detection process and (ii) a time at which the time detection process is performed last time.

7. The communication apparatus as defined in claim 5,
wherein, the first time detection means figures out the process execution schedule time at which the time detection process is executed next, with reference to (i) a waiting period from the time detection process to the next time detection process and (ii) a time at which the time detection process is performed last time.

8. The communication apparatus as defined in claim 4,
wherein, the first time detection means regularly figures out the first apparatus time, the first reference time, or another time, and executes the time detection process if the time thus figured out is equal to or later than the process execution schedule time.

9. The communication apparatus as defined in claim 5,
wherein, the first time detection means regularly figures out the first apparatus time, the first reference time, or another time, and executes the time detection process if the time thus figured out is equal to or later than the process execution schedule time.

10. A communication apparatus which is a non-clock master and synchronizes a first apparatus time of a clock master with a second apparatus time of the communication apparatus,
the communication apparatus comprising:
second apparatus time clocking means for clocking the second apparatus time;
second time detection means for performing a time detection process to detect, substantially at the same time, the second apparatus time and a second reference time synchronized with a first reference time referred to by the clock master;
receiving means for receiving the first apparatus time and the first reference time from the clock master; and
time adjustment means for adjusting the second apparatus time, with reference to the detected second apparatus time, the detected second reference time, the received first apparatus time, and the received first reference time.

11. The communication apparatus as defined in claim 10,
wherein, the time adjustment means adjusts the second apparatus time clocking means by an adjustment value figured out by:
adjustment value=(second apparatus time−first apparatus time)−(second reference time−first reference time).

12. The communication apparatus as defined in claim 10,
wherein, if a gap between the first apparatus time and the second apparatus time is larger than a predetermined value, the time adjustment means sets a current time of the second apparatus time clocking means to be identical with the received first apparatus time, whereas if the gap is not larger than the predetermined value, the time adjustment means determines to what extent clocking speed of the second apparatus time clocking means is increased or decreased, in accordance with the degree of the gap.

13. The communication apparatus as defined in claim 10, further comprising second reference time clocking means for clocking the second reference time,
the second time detection means detecting the second reference time from the second reference time clocking means.

14. The communication apparatus as defined in claim 10,
wherein, the second time detection means detects the second apparatus time after detecting the second reference time.

15. The communication apparatus as defined in claim 10,
wherein, the second time detection means performs the time detection process at a predetermined process execution schedule time.

16. The communication apparatus as defined in claim 15,
wherein, the process execution schedule time periodically comes.

17. The communication apparatus as defined in claim 15,
wherein, the second time detection means figures out the process execution schedule time at which the time detection process is executed next, with reference to a waiting period from the time detection process to the next time detection process, and a time at which the last time detection process is executed.

18. The communication apparatus as defined in claim 16,
wherein, the second time detection means figures out the process execution schedule time at which the time detection process is executed next, with reference to a waiting period from the time detection process to the next time detection process, and a time at which the last time detection process is executed.

19. The communication apparatus as defined in claim 15,
wherein, the second time detection means regularly figures out the second apparatus time, the second reference time, or another time, and performs the time detection process if the time thus figured out is equal to or later than the process execution schedule time.

20. The communication apparatus as defined in claim 16,
wherein, the second time detection means regularly figures out the second apparatus time, the second reference time, or another time, and performs the time detection process if the time thus figured out is equal to or later than the process execution schedule time.

21. A communication system, comprising:
a communication apparatus which is a clock master; and
a communication apparatus which is a non-clock master,
the communication apparatus as the clock master including:
first apparatus time clocking means for clocking a first apparatus time of the clock master;
first time detection means for executing a time detection process to detect, substantially at the same time, the first apparatus time and a first reference time synchronized with a second reference time referred to by the non-clock master; and
sending means for sending, to the non-clock master, the detected first apparatus time and first reference time,
the communication apparatus as the non-clock master, which synchronizes the first apparatus time of the clock master with the second apparatus time of the non-clock master, including:
second apparatus time clocking means for clocking the second apparatus time;
second time detection means for performing a time detection process to detect, substantially at the same time, the second apparatus time and the second reference time synchronized with the first reference time referred to by the clock master;
receiving means for receiving the first apparatus time and the first reference time from the clock master; and
time adjustment means for adjusting the second apparatus time, with reference to the detected second apparatus time, the detected second reference time, the received first apparatus time, and the received first reference time.

22. The communication system as defined in claim 21,
wherein, the first reference time and the second reference time are indicated by a single external clock.

23. A synchronization method for a communication apparatus, for synchronizing a first apparatus time which is a time of a clock master with a second apparatus time which is a time of a non-clock master,
the method comprising the steps, executed by a communication apparatus as the clock master, of:
clocking the first apparatus time;
detecting, substantially at the same time, the first apparatus time and a first reference time which is synchronized with a second reference time referred to by the non-clock master; and
sending the detected first apparatus time and first reference time to the non-clock master,
the method further comprising the steps, executed by a communication apparatus as the non-clock master, of:
clocking the second apparatus time;
detecting, substantially at the same time, the second apparatus time and the second reference time;
receiving the first apparatus time and the first reference time; and
adjusting the second apparatus time with reference to the detected second apparatus time, the detected second reference time, the received first apparatus time, and the first reference time.

24. A communication apparatus control program for causing a computer to function as means of a communication apparatus which is a clock master,
the communication apparatus including:
first apparatus time clocking means for clocking a first apparatus time which is a time of the communication apparatus;
first time detection means for executing a time detection process to detect, substantially at the same time, the first apparatus time and a first reference time synchronized with a second reference time referred to by a non-clock master; and
sending means for sending, to the non-clock master, the detected first apparatus time and first reference time.

25. A communication apparatus control program for causing a computer to function as means of a communication apparatus which is a non-clock master and synchronizes a first apparatus time of a clock master with a second apparatus time which is a time of the communication apparatus,
the communication apparatus including:
second apparatus time clocking means for clocking the second apparatus time;
second time detection means for performing a time detection process to detect, substantially at the same time, the second apparatus time and a second reference time synchronized with the first reference time referred to by the clock master;
receiving means for receiving the first apparatus time and the first reference time from the clock master; and
time adjustment means for adjusting the second apparatus time, with reference to the detected second apparatus time, the detected second reference time, the received first apparatus time, and the received first reference time.
